(19) United States
(12) Patent Application Publication
(10) Pub. No.: US 2014/0199160 A1
(43) Pub. Date: Jul. 17, 2014

(54) WIND TURBINE WITH TWO SETS OF BLADES AND METHOD OF OPERATION THEREOF

(71) Applicant: Paul Merswolke, Bognor (CA)

(72) Inventor: Paul Merswolke, Bognor (CA)

(21) Appl. No.: 14/238,150

(22) PCT Filed: Aug. 8, 2012
(86) PCT No.: PCT/CA2012/000754

§ 371 Date: Feb. 10, 2014

Related U.S. Application Data
(60) Provisional application No. 61/521,602, filed on Aug. 9, 2011.
(60) Provisional application No. 61/679,700, filed on Aug. 4, 2012.

(51) Int. Cl. F03D 3/02

(52) U.S. Cl. CPC F03D 3/02
USPC 415/1; 415/60

(57) ABSTRACT

An air turbine has two sets of blades concentrically mounted on a rotatable shaft. The two sets of blades are housed separately and an air supply for the turbine enters an air inlet of a first housing to drive a first set of blades and exits from the first housing to a second housing through an air transfer opening to drive the second set of blades in the same direction, the air exiting the second housing through an air outlet. Returning blades of each cycle of each set of blades is subjected to little or no resistance. A flywheel is concentrically mounted on the shaft and is connected to drive generators. The air supply is a controlled air supply and, preferably, the air supply is compressed air. The shaft of the turbine is oriented to the either horizontal or vertical.

### BACKGROUND OF THE INVENTION

1. Field of the Invention

This invention relates to an air turbine and method of operating the turbine. The turbine has two sets of blades mounted on a rotatable main shaft. More particularly, this invention relates to an air turbine in which the two sets of blades are housed separately and controlled air supply for the turbine is introduced into an air inlet to one set of blades, then into an air inlet for the other set of blades and to an air outlet so that returning blades of each set are subjected to little or no resistance.

2. Description of the Prior Art

Vertical axis and horizontal axis wind turbines are known. Some vertical axis wind turbines have blades that pivot about a longitudinal axis of each blade to maximize resistance on the power side of the wind turbine and to minimize resistance on the return side. In Estrada US Patent Application Publication No. 2010/0270806, a vertical axis wind turbine has blades located in a rotatable housing were wind is directed onto accepting blades while shielding returning blades from the oncoming wind.

Wind turbines are usually mounted on a tower so that they are some distance into the air in order to catch the wind.

### SUMMARY OF THE INVENTION

It is an object of the present invention to provide an air turbine that has two sets of blades rotatably mounted on a shaft, the two sets of blades being located within separate compartments of a housing and supplied with compressed air to move the blades in one direction with little or no resistance to the return of the blades.

An air turbine comprises a substantially rotatable shaft with two sets of blades concentrically mounted thereon. The two sets of blades are a first set and a second set, the first set being located apart from the second set. A flywheel is concentrically mounted on the shaft, the flywheel being arranged to drive energy producing equipment as the shaft rotates. The two sets of blades are located in separate compartments of a housing, the separate compartments being a first compartment and a second compartment to house the first set and second set respectively. An air inlet is located in the first compartment, an air transfer opening is located between the first compartment and the second compartment and an air outlet is located in the second compartment. The air inlet and the air transfer opening are located so that air entering the first compartment can drive the first set of blades through part of a rotation before exiting through the air transfer opening, the air transfer opening and the air outlet being located so that air entering the second compartment can drive the second set of blades through part of a single rotation in the same direction as the first set before exiting through the air outlet, there being a source of air to power the turbine.

The air inlet and the air transfer opening are located substantially 180 degrees from one another and the air transfer opening and the air outlet are located substantially 180 degrees from one another when viewed along the shaft.

A method of operating an air turbine wherein the turbine has a first set of blades and a second set of blades that are concentrically mounted on a rotatable shaft. The two sets of blades are located within separate compartments of a housing. A flywheel is concentrically mounted on the shaft, the flywheel being connected to energy producing equipment. The method comprises locating an air inlet in the first compartment, an air transfer opening between the first compartment and the second compartment and an air outlet in the second compartment, introducing a source of air into the air inlet of the first compartment of the housing to drive the first set of blades, the air exiting from the first compartment to the second compartment through the air transfer opening, the air driving the second set of blades in the same direction as the first set of blades and exiting the second compartment through the air outlet.

### BRIEF DESCRIPTION OF THE DRAWINGS

FIG. 1 is a schematic side view of a vertical axis air turbine;

FIG. 2 is a schematic side view of the vertical axis air turbine of FIG. 1;

FIG. 3 is a schematic top view of sets of blades with an air stream shown thereon;

FIG. 4 is a cross sectional view of an end of one blade in the compartment;

FIG. 5 is a partial flow diagram of a process of the present invention;

FIG. 6 is a schematic view of a second vertical axis air turbine;

FIG. 7 is a schematic side view of a horizontal axis air turbine;

FIG. 8 is a partial schematic side view of a turbine having air bearings thereon; and

FIG. 9 is a schematic side view of a nacelle for an air turbine having drive wheels connected to drive belts which in turn drive energy producing equipment.

### DETAILED DESCRIPTION OF A PREFERRED EMBODIMENT

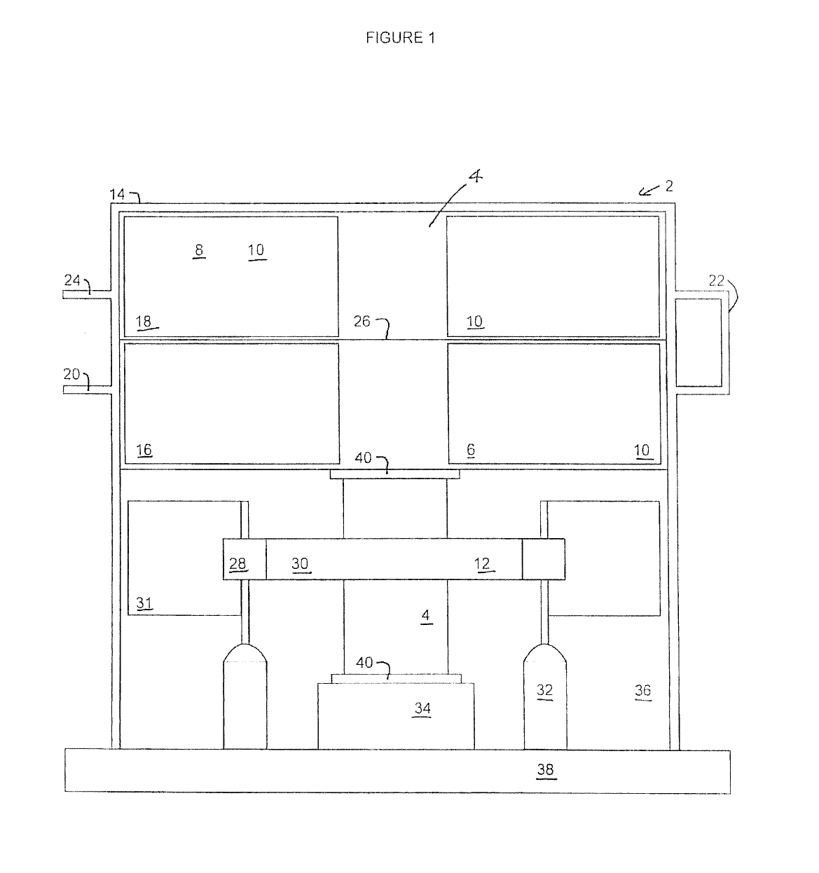

In FIG. 1, a vertical axis air turbine 2 has a rotatable shaft 4 with two sets 6, 8 of blades 10 concentrically mounted thereon. A first set 6 is mounted beneath a second set 8. A flywheel 12 is also concentrically mounted on the shaft 4. The two sets 6, 8 of blades 10 are located in a housing 14. The first set 6 of blades 10 is located in a first compartment 16 and a second set 8 of blades 10 as located in a second compartment 18 of the housing 14. The first compartment has an air inlet 20 and there is an air transfer opening 22 between the two compartments 16, 18 opposite to the air inlet 20. The second compartment 18 has an air outlet 24 opposite to the air transfer opening 22. The air transfer opening 22 is an air outlet from the first compartment 16 and an air inlet to the second compartment 18.

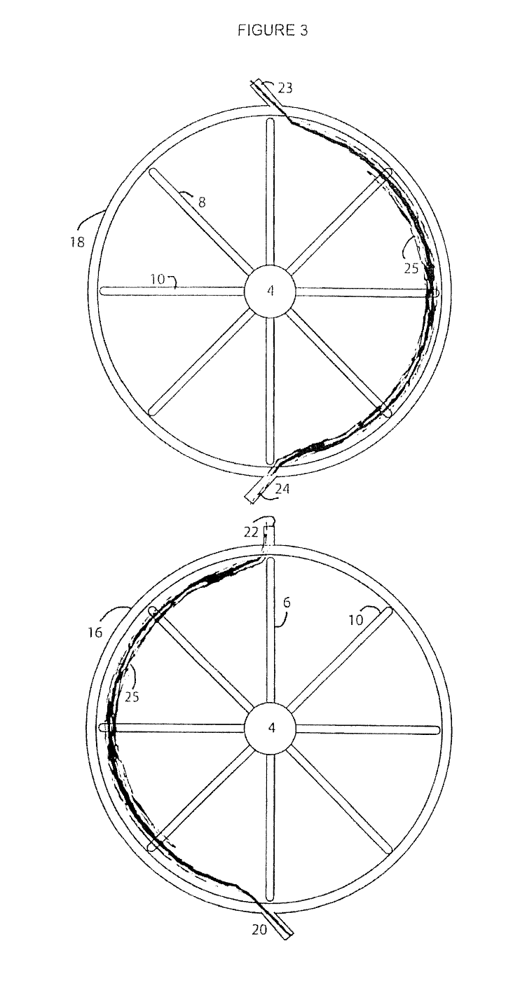

Preferably, the air transfer opening 22 is located substantially 180 degrees from the air inlet 20 and substantially 180 degrees from the air outlet 24 (best seen in FIG. 3). The flywheel is preferably a weighted flywheel.

The compartments 16, 18 can be separate housings, but are preferably separate compartments of the same housing 14. Preferably, the first compartment is located beneath the second compartment, the air passing from the first compartment to the second compartment. Alternatively, the first compartment can be located above the second compartment. The compartments 16, 18 are separated from one another by horizontal wall 26. Drive wheels 28 are mounted to be removably in contact with a circumference 30 of the flywheel 12. Preferably, the drive wheels are tires. Other drive mechanisms can be used including belts, chains, gears or other friction drive components other than drive wheels. Pressure bearings 31 (or tire carrier or V-belt drive) are mounted to increase or decrease a pressure between the drive wheels 28 and the flywheel 12. Preferably, the pressure bearings can independently control the pressure of each drive wheel and can remove any or all of the drive wheels from contact with the flywheel. The drive wheels 28 are connected to drive generators 32 or other energy producing equipment. A plurality of drive wheels and a plurality of generators can be used. The shaft 4 is preferably mounted on a concrete base 34 and preferably the housing 14 includes a third compartment 36 in which the flywheel 12 and enemy producing equipment is located. The housing 12 preferably has a concrete floor 38. There are slew bearings 40 mounted on the shaft 4 to allow the shaft to rotate. The blades 10 and the flywheel 12 rotate with the shaft 4. There can be an additional slew bearings 40 at the top of the housing 14. A seal (not shown) is located between the shaft 4 and the wall 26 to prevent air from escaping from the first compartment 16 to the second compartment 18 between the shaft 4 and the wall 26.

The turbine 2 has a controlled air supply (not shown) that is preferably compressed air sufficient to maintain a required speed of the flywheel. The compressed air can be in a range from 50 to 250 psi and still more preferably from 80 to 250 psi. The dimensions provided in FIG. 1 are suggested dimensions only for the turbine shown in FIG. 1. The size of the turbine can be larger or smaller than that shown in FIG. 1. The blades can be any reasonable size.

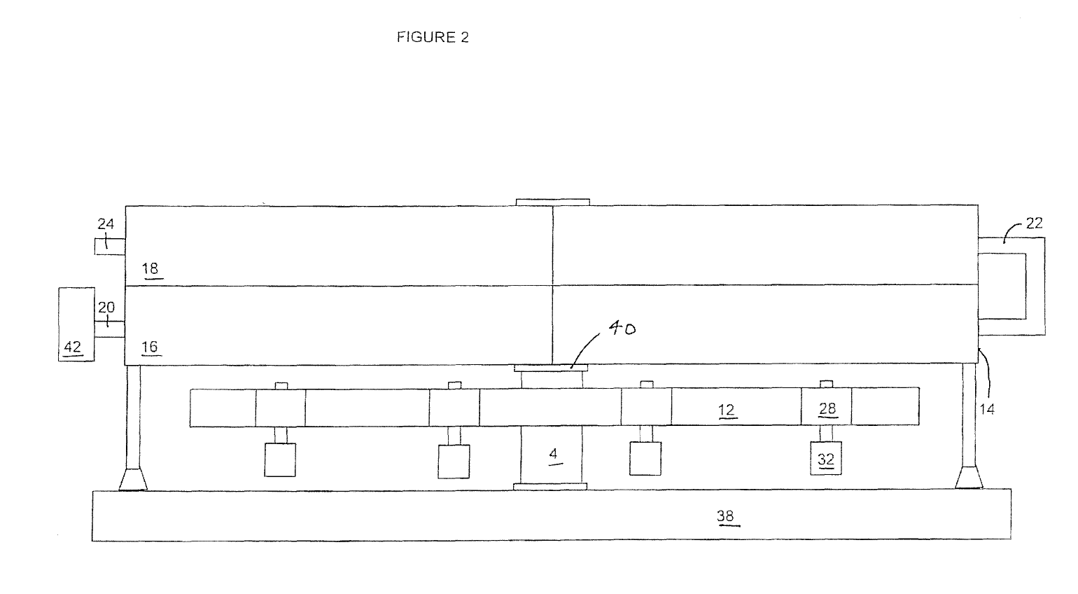

In FIG. 2, there shown a schematic side view of the turbine 2 with the drive portion and return portion of each set of blades. It can be seen (by comparing FIGS. 1 and 2) that when the first set of blades is being driven by the compressed air supply 42, the second set 8 of blades of the blades 10 is in the return portion of the cycle and when the second set 8 is in the drive portion, the first set 6 of blades is in the return portion. Therefore, one set of blades is always being driven while simultaneously the other set of blades is in the return cycle with little or no resistance.

In FIG. 3, there is shown a schematic top view of each set 6, 8 of the blades 10 in the two compartments 16, 18 respectively. In the first compartment, it can be seen that the supply air enters the air inlet 20 and travels substantially 180 degrees to the air transfer opening 22 where the air exits the first compartment 16 and enters the second compartment 18. The air inlet 20 and an inlet portion 23 to the second compartment of the air transfer outlet 25 are angled to force the two set of blades to rotate in the same direction. The air in the second compartment completes the cycle (i.e. one revolution) and drives the blades 10 of the second set 8 for substantially 180 degrees where the air is exhausted through the air outlet 24. It can be seen that there is little or no resistance to the blades in the return part of the cycle for each set. The blades 10 in the first set 6 may or may not be identical to the blades 10 in the second set 8. For example, there may be fewer blades in the second set 8, or the shape of the blades may be different.

In operation, the compressed air is introduced into the air inlet 20 of the first compartment 16. The compressed air is directed to drive the blades 10 in a particular direction, for example, a clockwise direction when the turbine is viewed from above. The compressed air in the first compartment 16 enters the second compartment through the air transfer opening 22 and is directed to cause the second set of blades 10 to rotate in the same direction as the first set 6. The compressed air entering the second compartment 18 through the air transfer opening 22 is exhausted from the first compartment through the air outlet 24. Since the compressed air travels substantially 180 degrees in each compartment, the blades of each set 6, 8 are driven substantially 180 degrees and there is little or no resistance to the blades rotated through the return portion of the cycle to a beginning of a new cycle where the blades are again driven by the controlled air supply. The compressed air is preferably pulsated to maintain the speed of the flywheel. Pulsation allows less air compressed to be used to drive the blades 10 at the same speed as using a continuous supply of air.

The housing 14 is stationary while the shaft 4, two sets 6, 8 of blades 10 and flywheel 12 rotate together in response to the controlled air supply. The blades and housing can be various sizes depending on the output required. For example, the length of each blade can range from three metres to sixty metres. The housing is sized to be slightly larger then a circumference through tips of the blades. The turbine 2 preferably has no yaw control as the air supply is controlled and the housing 14 is stationary and does not rotate.

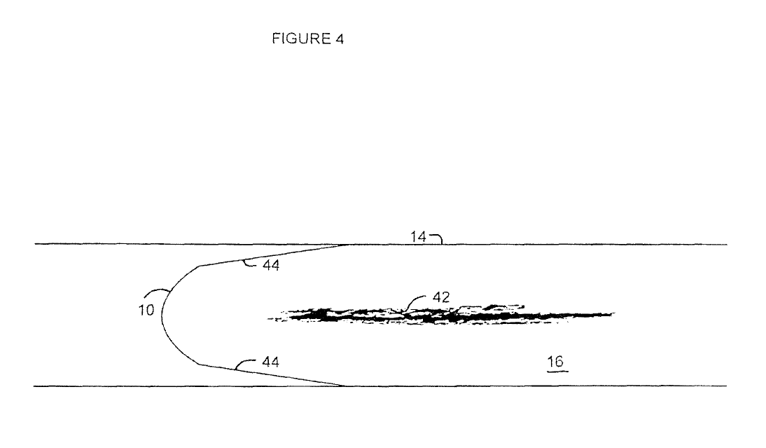

In FIG. 4, there is shown a schematic cross section of the shape of one of the blades 10 at an outer end thereof. It can be seen that a tip of the blade has a substantially U-shaped cross section or cup shape with the U-shape or cup shape being turned on its side and being open to receive supply air 42 into an interior of the U-shape or cup shape. Arms 44 of the U-shape are angled at 12 degrees to the upper and lower walls of the compartment 16 of the housing 14. The blades 10 of each set are preferably identical to one another. The compressed air can be directed to an area of each of the tips of the blades, for example the outer 10% of each of the blades. Blades of various shapes can be used.

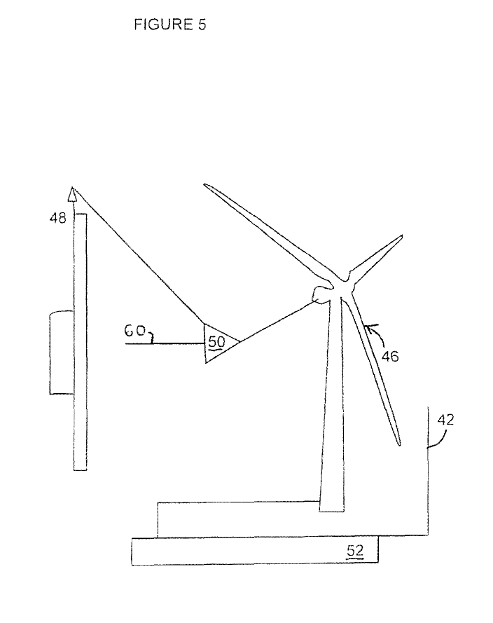

In FIG. 5, there shown a schematic flow diagram showing compressed air being produced by output from a horizontal axis air turbine 46 and/or off peak electricity from a utility 48 to power compressors 50. The compressed air is preferably stored in a storage area, for example, a salt cavity 52 or large three foot diameter gas pipes 52 to hold the compressed air. Compressed air can then be removed from storage to supply air 42 to the vertical axis air turbine of the present invention (not shown in FIG. 5).

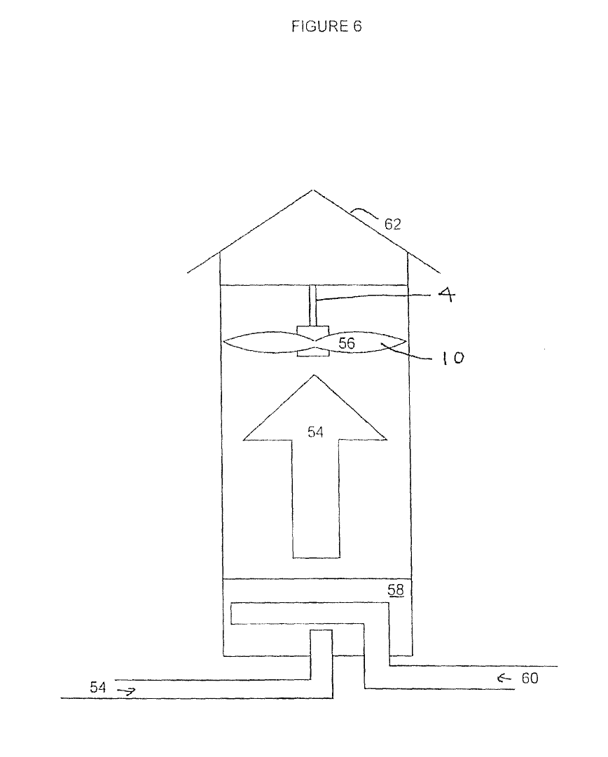

In FIG. 6, exhaust air 54 from the air outlet of the second compartment 18 (not shown in FIG. 6) of the air turbine 2 is fed into a vertical axis air turbine 56. Since the exhaust air is fed into the blades 10 of the turbine in a direction parallel to the shaft 4, the turbine 56 could be described as a horizontal air turbine even though the shaft is vertical. The exhaust air is fed through perforated concrete or stone 58 along with heat of compression 60 to power the horizontal axis turbine 56 that is mounted in a tower 62. The turbine 56 is optional and increases the efficiency of the vertical axis air turbine 2 by producing additional energy from the exhaust air of the turbine 2.

When the main shaft 4 rotates, the first set of blades, the second set of blades and the flywheel rotate with the shaft 4. When the air supply rotates the first set of blades, the shaft, the second set of blades and the flywheel rotate with the first set of blades. Similarly, when the air supply rotates the second set of blades, the shaft, the first set of blades and the flywheel rotate with the second set of blades. Since the air supply is controlled, there is no requirement to locate the air turbine 2 on a tower. The air turbine 2 can be located at ground level. The turbine 2 has a high efficiency level.

When the air supply is pulsated as it is directed to flow into the inlet 20, the blades 10 of the turbine 2 can be driven to rotate at the desired speed with less air than would be required to rotate the blades 10 at the desired speed without pulsation. It is estimated that the saving in the amount of air required is approximately fifty percent.

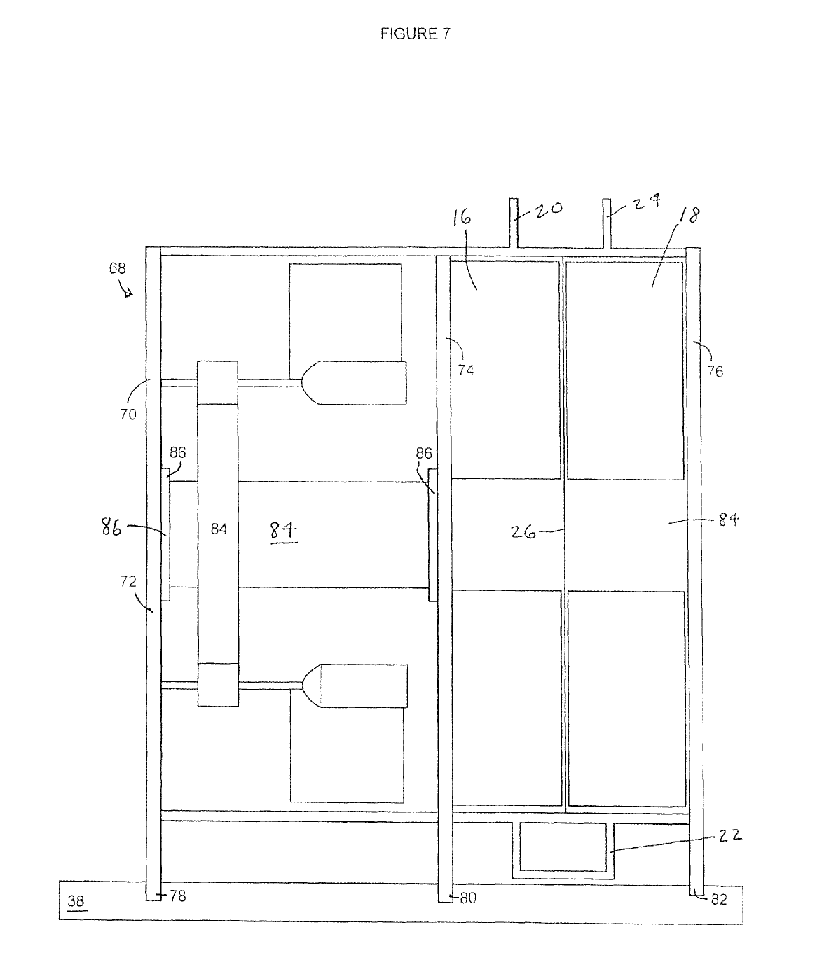

In FIG. 7, there is shown a further embodiment of an air turbine 68 that is virtually identical to the air turbine 2 shown in FIGS. 1 to 4 except that the air turbine 68 is oriented 90 degrees relative to the air turbine 2. The same reference numerals are used in FIG. 7 as those used in FIG. 1 to describe those components that are identical. A housing 70 has three vertical walls 72, 74, 76 with bases 78, 80, 82 respectively mounted on the floor 38 to support a horizontal shaft 84. The horizontal shaft 84 is rotatably mounted in bearings 86, which are preferably pillow block bearings. The air turbine 68 operates in the same manner as the air turbine 2 with a controlled air supply that is preferably compressed air. A seal (not shown) is located between the shaft 84 and the wall 26 to prevent air from escaping from the first compartment 16 to the second compartment 18 between the shaft 84 and the wall 26. The schematic flow diagram shown in FIG. 5 and the exhaust air 54 from the air outlet 24 of the second compartment 18 as described in FIG. 6 apply equally as well to the turbine 68 as to the turbine 2 as to the shape of the blades in FIG. 4. Except for the orientation, the description of FIGS. 2 and 3 also applies to the turbine 68 shown in FIG. 7. Since both turbines 2 and 68 use a controlled air supply that is preferably compressed air, the turbines can be constructed at ground level. For the turbine 68, the length of the blades will largely determine the height of the turbine and the diameter of the housing.

Since a controlled air supply is utilized to drive the turbine of the present invention, the orientation of the shaft of the turbine can be any suitable orientation between horizontal and vertical. Also, more than two sets of blades can be used with each set being in separate compartments of the housing. The controlled air supply can be directed from the controlled air supply directly into any or all of the compartments. For example, if there are two compartments the controlled air supply can be connected to two inlets, one inlet in each compartment, or, if there are four compartments, the controlled air supply can be connected directly into the first and third compartments and through an air transfer opening from the first to the second compartment and through an air transfer opening from the third to the fourth compartment. The outlet from each compartment will be changed to correspond to the inlet arrangement. For example, when there are two compartments and two sets of blades with the air supply directly connected to an air inlet of each compartment, there will be air outlets from each compartment approximately 180 degrees apart from the air inlets and there will not be any air transfer openings between compartments. In a further embodiment, the compressed air entering the second compartment can be replenished with compressed air having a higher pressure to increase the overall pressure of the compressed air entering the second compartment. For example, if the compressed air entering the first compartment has a pressure of 80 psi, the air entering the second compartment can be replenished to air having a pressure of 80 psi. Without replenishment, the air entering the second compartment will have a lower pressure than the air entering the first compartment.

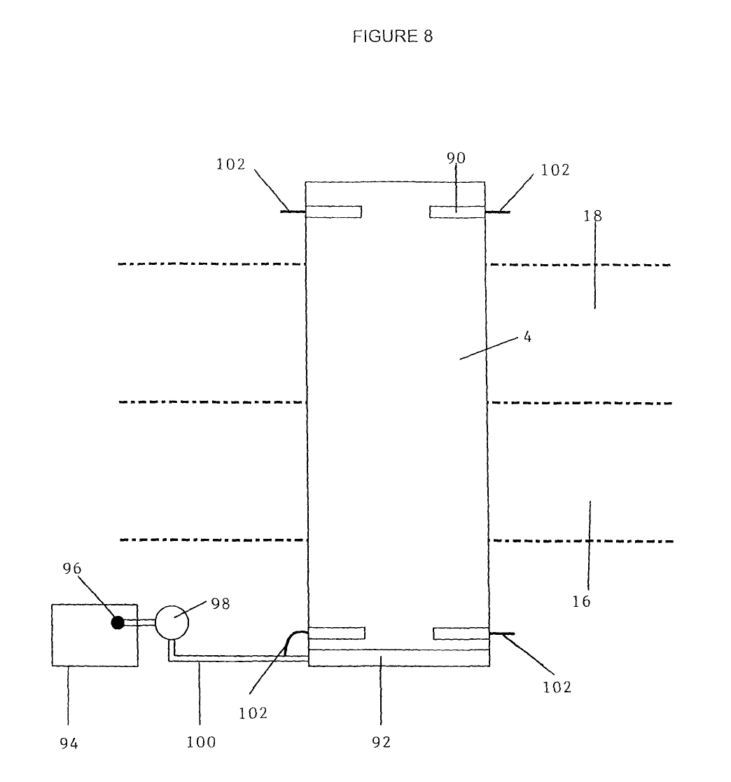

In FIG. 8, there is shown a partial schematic side view of the shaft 4 having compartments 16, 18 mounted thereon with four radial air bearings 90 and one flat air bearing 92. The air bearings are connected to a source 94 of compressed air that passes through a one way valve 96 to a compressed air tank 98 to supply compressed air to the air bearings 90, 92 through compressed air lines 100, 102. The direct connection between some of the compressed air lines 102 and the compressed air line 100 are only partially drawn for ease of illustration. The bearings used with the turbine of the present invention can be air bearings or regular bearings or levitational devices that use a magnetic levitation (MagLev, a trade-mark) technique.

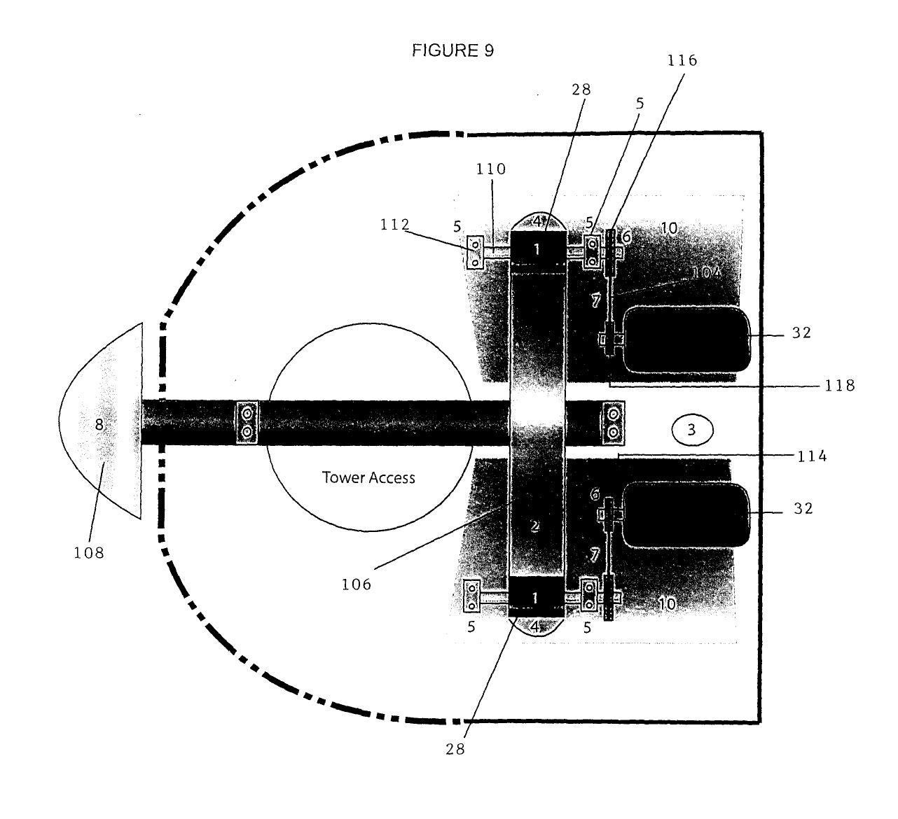

In FIG. 9, there is shown a combination of drive wheels 28 driving energy producing equipment 104 by belts rotatably connected between the drive wheels 28 and the energy produced in the equipment 32. The energy producing equipment 32 can, for example, be generators 32. The drive wheels 28 are in contact with a flywheel 106 concentrically mounted on the shaft 4 along with a rotor 108, which is also concentrically mounted on the shaft 4. As the shaft 4 rotates the flywheel 106, the wheels 28 also rotate in turn driving a shaft 110 on which each wheel 28 is mounted. The shaft 110 each wheel 28 are rotatably mounted in bearings 112. The belts 104 are rotatably connected between each of the shafts 28 and a rotatable shaft 114 on the energy producing equipment 32. Preferably, the energy producing equipment 32 is a plurality of induction generators, but other generators can be used, for example, permanent magnet generators.

An advantage of the combination of the wheels 28 causing the belts 104 to rotate a shaft 114 of the energy producing equipment 32 is that the speed of rotation that the belts impart through the shaft 11 impart of each piece of energy producing equipment 32 can be controlled over a broad range to be much faster or much slower than a speed of rotation of the wheels 28 by appropriately sizing a pulley 116 mounted on each of the shafts 110 relative to a pulley 118 mounted on the shafts 114 of the energy producing equipment 32. The pulley 116 mounted on the shaft 110 has a much larger diameter than the pulley 118 mounted on the shaft 114 of the energy producing equipment 32. Therefore, each single rotation made by the pulley 116 causes multiple rotations to be made by the pulley 118 on the shaft 114 of the energy producing equipment 32. For example, by choosing an appropriate size ratio between the pulley 116 and the pulley 118, the pulley 118 can be made to rotate much faster than the shaft 110 rotates. For example, the pulley 118 and therefore the shaft 114 can be made to rotate ten times faster than the shaft 110 and the wheels 28. As a result, the blades (not shown in FIG. 9) and the flywheel 106 can be made much smaller because of the rotational adjustment that is made possible by use of the combination of the wheels 28 and belts 104 to achieve the same speed of rotation as a much larger turbine and flywheel would achieve. In other words, a turbine with a much smaller power output can produce the same power that was previously produced by a much larger turbine. Preferably, the pulleys are sized to increase the speed of rotation of the belts and of the energy producing equipment.

Since the turbine of the present invention has a controlled air supply, the speed of the turbine can be accurately in turn controlled as desired. For example, the speed of the turbine can be controlled to control the speed of drive system for the energy producing equipment to cause the energy producing equipment to produce electricity having a frequency that can be fed to the grid.

The air turbine of the present invention is powered, not by wind, a source of nature, but by compressed air.

I claim:

1. An air turbine comprising a rotatable shaft with two sets of blades concentrically mounted thereon, the two sets of blades being a first set and a second set, the first set being located apart from the second set, a flywheel being mounted to rotate with the shaft, the flywheel being arranged to drive energy producing equipment as the shaft rotates, the two sets being located in separate compartments of a housing, the separate compartments being a first compartment and a second compartment to house the first set and second set respectively, the first and second compartments having first and second air inlets and air outlets respectively, the first air inlet and the first air outlet being located so that air entering the first compartment can drive the first set of blades through part of a rotation before exiting through the first air outlet, the second air inlet and the second air outlet being located so that air entering the second compartment can drive the second set through part of a rotation in the same direction as the first set before exiting through the second air outlet, there being a controlled source of air to power the turbine.

2. The air turbine as claimed in claim 1 wherein the flywheel is concentrically mounted on the shaft.

3. The air turbine as claimed in claim 2 wherein the first air outlet and the second air outlet are aligned with one another to constitute an air transfer opening.

4. The air turbine as claimed in claim 3 wherein the distance between the air inlet and the air transfer opening is substantially 180 degrees and the distance between the air transfer opening and the air outlet is substantially 180 degrees.

5. The air turbine as claimed in claim 4 wherein the distance between the air inlet and the air transfer opening does not exceed 180 degrees and the distance between the air transfer opening and the air outlet does not exceed 180 degrees.

6. The air turbine as claimed in claim 4 wherein the tip of each of the blades has an inverted U-shape.

7. The air turbine as tried in claim 6 wherein the inverted U-shape has upper and lower arms of the U-shape that form an angle of substantially 12 degrees with substantially horizontal walls above and below the blades of the compartments in which the blades are located.

8. The air turbine as claimed in claim 4 wherein the tip of each of the blades is cup shaped.

9. The air turbine as claimed in claim 7 wherein the source of air is a compressed air supply.

10. The air turbine as claimed in claim 9 wherein the supply of compressed air is controlled to pulsate.

11. The air turbine as claimed in claim 4 wherein there is a drive for the energy producing equipment that is at least one of a friction drive, wheels, tires, belts, chains and gears.

12. The air turbine as claimed in claim 9 wherein the compressed air has a pressure of 50 to 250 psi.

13. The air turbine as claimed in claim 9 wherein the compressed air has a pressure of 80 to 250 psi.

14. The air turbine as claimed in any claim 4 wherein the rotatable shaft is one of vertical or horizontal.

15. The air turbine a claimed in claim 9 wherein to fresh supply of compressed air is provided to increase the pressure of the compressed air entering the second compartment.

16. The air turbine as claimed in claim 1 wherein wheels are in rotatable contact with the flywheel and connected to rotate belts that in turn are connected to power energy producing equipment.

17. The air turbine as claimed in claim 16 wherein the wheels are tires and the belts are mounted on pulleys that are sized to increase the speed of rotation of the energy producing equipment beyond the speed of rotation of the tires.

18. A method of operating an air turbine wherein the turbine has a first set of blades and a second set of blades that are concentrically mounted on a rotatable shaft, the two sets of blades being located apart from one another within separate compartments of a housing, a flywheel being mounted to rotate with the shaft, the flywheel being connected to drive energy producing equipment, the method comprising locating first and second air inlets and first and second air outlets in a first compartment and a second compartment respectively, introducing a controlled source of air into the first air inlet of the first compartment to drive the first set of blades through part of a rotation before exiting from the first air outlet and entering the second air inlet of the second compartment to drive the second set of blades through part of a rotation in the same direction as the first set of blades are rotating before exiting through the second air outlet.

19. The method as claimed in claim 18 including the step of using a controlled source of air to supply air into the air inlet of the first compartment.

20. The method as claimed in claim 19 including the step of introducing a controlled source of compressed air into the air inlet of the first compartment.

21. The method as claimed in claim 20 including the step of pulsating the compressed air enters the air inlet of the first compartment.

22. The method as claimed in claim 18 inducting the step of choosing to orient the rotatable shaft of the turbine to be either horizontal or vertical.

23. The method as claimed in claim 18 including the steps of locating the first air inlet and first air outlet substantially 180 degrees apart from one another, locating the second air inlet substantially in the same location as the first air outlet and locating the second air inlet and the second air outlet substantially 180 degrees apart from one another.

24. The method as claimed in claim 22 including the steps of combining the first air outlet and the second air inlet into an air transfer opening extending between the first compartment and the second compartment.

25. The method as claimed in claim 20 including the steps of introducing a controlled source of compressed air directly into a second compartment in or near the second air inlet to increase the pressure of the air entering the second compartment from the first compartment.

26. The method as claimed in claim 18 including the steps of forming a drive for the energy producing equipment that is comprised of at least one of a friction drive, wheels, tires, belts, chains and gears.

27. The method as claimed in claim 26 including the steps of placing wheels in rotatable contact with the flywheel and connecting the wheels to rotate belts that are in turn connected to power the energy producing equipment.

28. The method as claimed in claim 27 including the steps of placing tires on the wheels and mounting the belts and pulleys that are sized to increase the speed of rotation of the energy producing equipment beyond the speed of rotation of the tires.

29. The method as claimed in claim 28 including the steps of using induction generators as the energy producing equipment.

30. The method as claimed in claim 28 including the steps of choosing the size of the pulleys to increase the speed of rotation of the energy producing equipment by at least is factor of two over the speed of rotation of the tires.

31. The air turbine as claimed in claim 17 where the power producing equipment are generators selected from the group of induction generators and permanent magnet generators.
